(19) United States
(12) Patent Application Publication
(10) Pub. No.: US 2022/0024719 A1
(43) Pub. Date: Jan. 27, 2022

(54) DEVICE FOR CREATING A TEMPORARY PROTECTIVE SPACE

(71) Applicant: Inventio AG, Hergiswil (CH)

(72) Inventors: Michael WEIGEL, Dohna (DE); Steffen THON, Winböhla (DE)

(21) Appl. No.: 17/309,415

(22) PCT Filed: Dec. 18, 2019
(86) PCT No.: PCT/EP2019/085965

§ 371 Date: May 26, 2021

(51) Int. Cl. B66B 5/00

(52) U.S. Cl. CPC B66B 5/0056

(57) ABSTRACT

A device for creating a temporary protective space for an elevator system is installed in an elevator shaft and includes a fastening element that can be fixed in the elevator shaft and a supporting element connected to the fastening element. In a maintenance position of the device, the supporting element is arranged such that a movement path of a travel body of the elevator system is limited to form the temporary protective space. An impact element is connected to the supporting element and, in the maintenance position of the device, provides direct mechanical contact with the travel body. The impact element is pivotably mounted on the supporting element such that in an operating position of the device the movement path of the travel body is maximized.

### FIELD

The invention relates to an elevator system having a device for creating a temporary protective space and to a device of this kind.

### BACKGROUND

Elevator systems usually comprise an elevator car and a counterweight which are arranged so as to be movable in opposite directions in an elevator shaft and are suitable for transporting passengers or goods. In order to keep such elevator systems operational, they have to be serviced from time to time. For this purpose, it is necessary for a maintenance technician to carry out maintenance activities in a shaft pit of the elevator shaft or on the elevator car in the shaft head of the elevator shaft. In order to ensure the safety of the maintenance technician, protective spaces are provided in the shaft head or in the shaft pit. These protective spaces are characterized by volumes having minimum dimensions in the shaft head or in the shaft pit, which volumes should not be penetrated by the elevator car during maintenance.

Efforts are also made to make the dimensions of the elevator shaft that are necessary for the operation of the elevator system as small as possible. This means that the dimensions of the elevator shaft are, as far as possible, only insignificantly greater than the dimensions which can accommodate the elevator car or the counterweight during an elevator journey.

As a result, the space in the shaft pit below a position of the elevator car in the lowest position thereof in the normal operating mode is too small to be able to form such a protective space. The same applies to a protective space in the shaft head that is to be arranged on the elevator car.

For this purpose there are devices for creating a temporary protective space, which devices can be arranged in the shaft pit or in the shaft head, below or above the elevator car or counterweight. If such a device is arranged in its maintenance position, a movement path of the elevator car is limited such that the protective space can be provided below the elevator car in the shaft pit or above the elevator car in the shaft head. In an operating position of this device, the elevator car can be moved within its entire movement path.

There are devices which can be fixed above/below the elevator car or the counterweight and have a supporting element which is pivoted into the movement path of the elevator car or the counterweight when the device is in the maintenance position. An impact plate is usually arranged on this supporting element, which impact plate is provided for contact with the elevator car or the counterweight and is accordingly designed so as to have correspondingly large dimensions.

### SUMMARY

An object of the invention is therefore that of providing a device for creating a temporary protective space or an elevator system having a device of this kind, the device having small dimensions in its operating position.

This object is achieved by a device for creating a temporary protective space, the device being suitable for an elevator system that can be installed in an elevator shaft, the device comprising: a fastening element which can be fixed in the elevator shaft; a supporting element which is connected, preferably directly, to the fastening element, it being possible for the supporting element to be arranged within the elevator shaft such that, in a maintenance position of the device, a movement path of a travel body belonging to the elevator system is limited in order to form the temporary protective space; and an impact element which is connected to the supporting element and which, in the maintenance position of the device, is provided for direct mechanical contact with the travel body, the impact element being pivotably mounted on the supporting element.

This object is also achieved by an elevator system having such a device for creating the temporary protective space, which device can be arranged or is arranged within the elevator shaft, the elevator system having a travel body which can be moved along an entire movement path in a normal operating mode of the elevator system.

During a normal operating mode of this kind, the at least one travel body, in particular the elevator car, can be moved without limitation in the elevator shaft. This means that all floors which are connected by the elevator shaft can be served by the elevator car, including the uppermost and lowermost of said floors. The device installed in the elevator shaft can therefore be arranged in its operating position during the normal operating mode of the elevator system.

If, however, the device installed in the elevator shaft is arranged in its maintenance position, the movement path of the corresponding travel body is limited by the device such that in particular the lowermost or the uppermost of these floors cannot be served by the elevator car.

The invention is based on the knowledge that the impact element usually has large dimensions for direct mechanical contact with the travel body. In the maintenance position of the device, said impact element is arranged at an angle, preferably perpendicularly, on the supporting element according to a main orientation of these components of the device. If this device is brought into its operating position, i.e. if the supporting element rests/is placed against a boundary wall of the elevator shaft, the angled arrangement of the impact element with respect to the supporting element, in accordance with the maintenance position, results in a large dimension of the device that protrudes into the elevator shaft.

In order to nevertheless allow a device which takes up as little space as possible in its operating position, in the operating position of the device, the impact element can be arranged in the elevator shaft so as to be as flat as the supporting element by means of the pivotability of said impact element on the supporting element. The pivotability can be achieved, for example, by means of hinges.

In a further development of the elevator system or the device, the supporting element is pivotably arranged on the fastening element. It is advantageous that the supporting element can thus be pivoted from the maintenance position into the operating position and vice versa. Accordingly, it is possible to transfer the parts of the device that can be fixed to the fastening element or the supporting element into the operating position of the device such that all components of the device can be stowed directly in the shaft pit or at another location, preferably in the elevator shaft.

In the maintenance position of the device, the supporting element can preferably be fixed to the fastening element by being snapped into position, and the impact element can preferably be fixed to the supporting element by being snapped into position, such that a higher level of safety is provided for the person in the protected space. In addition, in the operating position of the device, it is possible for the supporting element to be fixable to the fastening element, and preferably for the impact element to be fixable to the supporting element, by being snapped into position, in order to prevent a device which is fixed or can be fixed above the elevator car in the shaft head from entering the movement path of the elevator car, which can be moved without limitation, and colliding with said elevator car, for example. In the case of a device which can be arranged or is arranged on the elevator wall, safety can likewise be increased in this way.

Alternatively, the supporting element can be detachable from the fastening element such that the device can be transferred from its maintenance position to its operating position by means of this detachment. The supporting element and the impact element connected to the supporting element can thus be detached from the fastening element in their maintenance position in order to bring the device into its operating position and are stored in the elevator shaft independently of the fastening element during the normal operating mode of the elevator system.

Accordingly, the elevator system can comprise a second fastening element, to which second fastening element the supporting element can be fastened when the device is in the operating position. The second fastening element is preferably fixed directly to one of the boundary walls of the elevator system. It is advantageous that the supporting element and the impact element arranged thereon can thus be stowed in the elevator system such that the movement path of the travel body is possibly only limited by the fastening element to which the supporting element can be fixed in the maintenance position.

In a further development of the elevator system or the device, the supporting element can be fixed to the fastening element. This can be achieved by snapping into position, for example. Accordingly, secure fixing of the device or the supporting element to the shaft bottom or in the elevator shaft when the device is in the maintenance position is made possible.

In a further development of the elevator system, the travel body is formed by an elevator car of the elevator system or by a counterweight of the elevator system that can be moved in the opposite direction to the elevator car. By limiting the movement path of the elevator car or by arranging the device preferably below the elevator car, a temporary protective space of this kind can be created below the elevator car. If the device is arranged such that the movement path of the counterweight can be limited by the maintenance position of the device, it is possible for the temporary protective space to be arranged above the elevator car in the shaft head.

In a further development of the elevator system, the impact element has a pivot axle which is mounted on the supporting element such that, in the operating position of the device, the pivot axle is arranged between a central line of the supporting element that is oriented in the main orientation of the supporting element and a boundary wall of the elevator shaft. By means of such an arrangement, a maximum distance from the boundary wall that is assumed by the device in its operating position can be minimized. The boundary wall of the elevator shaft can be formed by a shaft wall of the elevator shaft, a shaft ceiling of the elevator shaft or a shaft bottom of the elevator shaft.

In a further development of the elevator system, the fastening element is fixed, preferably directly fixed, to the shaft wall or to the shaft bottom. By fixing the fastening element to the shaft wall, it is possible for the vertical dimension below the elevator car to the shaft bottom to be as small as possible. This means that the shaft pit can have the smallest possible depth. When the fastening element is fixed to the shaft bottom, it is possible for the device to be implemented with the lowest possible material expenditure, due to the forces of the travel body that can act on the device.

### DESCRIPTION OF THE DRAWINGS

The invention is explained in greater detail below with reference to drawings, which show:

FIG. 1: an elevator system with a first device for creating a temporary protective space and a further such device in their operating positions;

FIG. 2: an elevator system with devices for creating the temporary protective space arranged in their maintenance position;

FIG. 3: a device for creating the temporary protective space according to the previously known prior art; and

FIG. 4: a device for creating a temporary protective space arranged in its operating position.

### DETAILED DESCRIPTION

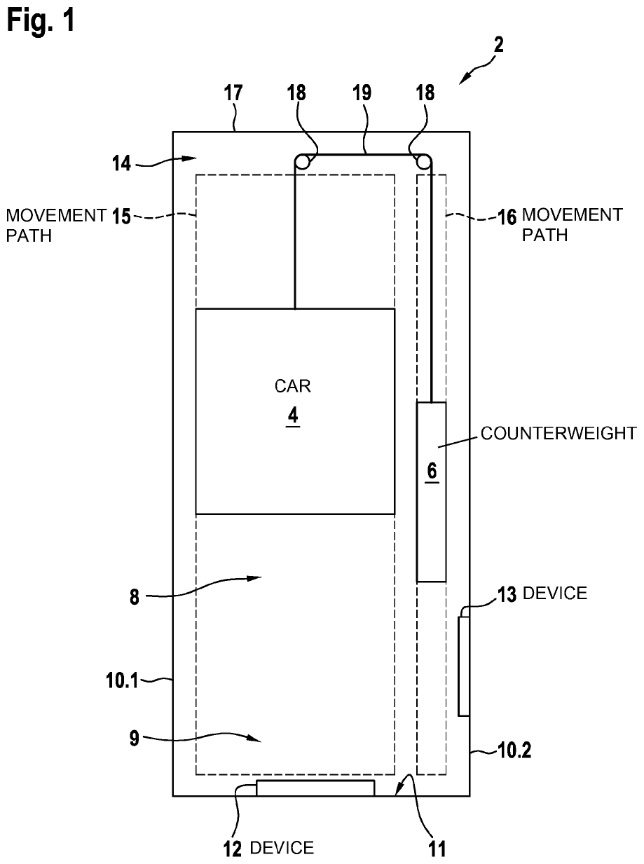

FIG. 1 shows an elevator system 2 arranged in an elevator shaft 8. The elevator shaft comprises a shaft head 14 at its upper end and a shaft pit at its lower end 9. The elevator shaft 8 is delimited by boundary walls 10.1, 10.2, 11, 17. The elevator shaft 8 is in particular delimited laterally by at least one shaft wall 10.1, 10.2 and at the lower end of the shaft pit 9 by a shaft bottom 11. The shaft head 14 can be delimited at its upper end by a shaft ceiling 17.

The elevator system 2 comprises at least one travel body, in particular an elevator car 4, which elevator car 4 can be displaced without limitation along its movement path 15. In addition to the elevator car 4, the elevator system 2 can comprise a further travel body, a counterweight 6, which can be arranged or is arranged in the elevator shaft 8 so as to be movable in the opposite direction to the elevator car 4. The counterweight 6 is arranged so as to be movable along a movement path 16 that can be assigned to the counterweight 6. During the normal operating mode of the elevator system 2, the counterweight 6 can be moved correspondingly without limitation along its movement path 16.

The elevator car 4 and the counterweight 6 are connected by means of a suspension element 19. The suspension element 19 can be deflected by means of rollers 18 in a shaft head 14 of the elevator shaft 8. One of the two rollers 18 shown can be designed as a drive roller connected to a drive motor (not shown).

The elevator system 2 comprises at least one device 12, 13 for creating a temporary protective space, a first shown device 12 of this kind being fixable to the shaft bottom 11 and a second shown device 13 of this kind being fixable to one of the shaft walls 10.1, 10.2. In the operating position of the device 12, 13, this device 12, 13 is arranged outside the movement path 15, 16 of the corresponding travel body 4, 6. This means that the device 12, 13 is arranged outside the volume which can be occupied by the elevator car 4 or the counterweight 6 in the normal operating mode of the elevator system 2. The devices 12, 13 are preferably at a distance from the movement path 15, 16 of the corresponding travel body 4, 6 when they are in their operating position.

Not shown is a device for creating the temporary protective space arranged above the elevator car 4, which device can be arranged in the shaft head 14 as an alternative to the arrangement of the device 13 below the counterweight 6.

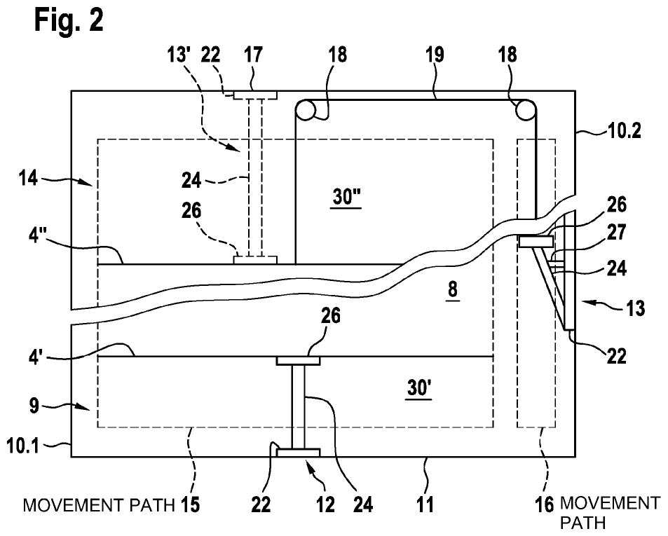

FIG. 2 shows the elevator system 2 shown in FIG. 1 with devices 12, 13 for creating the temporary protective space arranged in their maintenance position. In addition, the device 13′ which can be arranged above the elevator car and which can be an alternative to the device 13 arranged below the counterweight is shown. The devices 12, 13, 13′ for creating the temporary protective spaces 30′, 30″ are shown or arranged in their maintenance position.

Each of these devices 12, 13, 13′ comprises a fastening element 22 which is fixed or can be fixed in the elevator shaft 8, in particular to the shaft bottom 11, to one of the shaft walls 10.1, 10.2 or to the shaft ceiling 17, a supporting element 24 connected to the fastening element 22, and an impact element 26 connected to the supporting element 24.

The supporting element 24 is arranged so as to protrude from the shaft wall 10.2 or from the shaft bottom 11 such that the supporting element 24 protrudes into the movement path 15, 16 of the travel body 4, 6 and the impact element 26 is suitably placed for limiting the movement path of the travel body. As a result, the movement path 15, 16 of the travel body is limited in the maintenance position of the device 12, 13, 13′. In the maintenance position, the impact element 26 is arranged, preferably horizontally, such that a lower surface of the travel body (of the elevator car shown; 4′) can rest thereon. Accordingly, in the maintenance position of the device 12, 13, 13′, the impact element 26 is provided for direct mechanical contact with the travel body 4, 6. The lower surface of the elevator car 4 that is provided for striking the impact element 26 can be formed, for example, by a cross member of a frame of the elevator car 4.

When the lower surface 4′ of the elevator car 4 or a lowermost component of the elevator car 4 strikes the impact element 26 of the device 12 fixed to the shaft bottom 11, which element is arranged below said elevator car 4, a temporary protective space 30′ is formed below the elevator car 4.

The device 13 fixed to the shaft wall 10.2, which, in its maintenance position, limits the movement path 16 of the counterweight, causes the temporary protective space 30″ to be formed above the car roof 4″ in the shaft head 14 when the counterweight comes into mechanical contact with the impact plate 26. Alternatively, the fastening element 22 of the device 13 arranged below the counterweight can be fixed or fixable to the shaft bottom 11. In order to be able to absorb forces acting on the impact element 26, which are caused by the resting or striking of the counterweight, the device 13 can additionally have a stabilizing element 27. The stabilizing element 27 connects the supporting element 24 and the fastening element 22 such that the statics of the device 13 fixed to the shaft wall 10.2 is provided.

An additional buffer element (not shown) can be arranged on the impact element 26 or on the displacement body such that contact between the displacement body and the device 12, 13, 13′ is damped.

The device for creating the temporary protective space 30″ above the car roof 4″ can be arranged in the shaft head 14 as an alternative to the arrangement in the shaft pit 9. For this purpose, the fastening element 22 of the device 13′ arranged in the shaft head 14 can be fastened or fastenable to the shaft ceiling 17 or to the shaft walls 10.1, 10.2 in the shaft head 14.

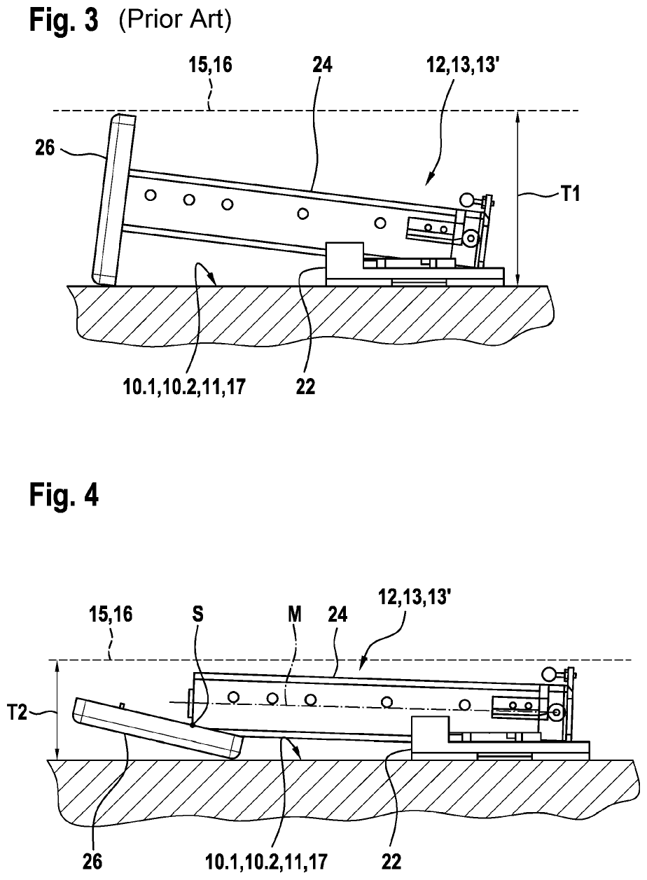

FIGS. 3 and 4 show devices 12, 13, 13′ for creating a temporary protective space. The supporting elements 24 of the device 12, 13, 13′ are directly connected to the fastening element 22 and are pivoted such that the device 12, 13, 13′ does not limit the movement path 15, 16 of the travel body.

FIG. 3 shows an impact element 26 according to the previously known prior art that is fixed to the supporting element 24. Accordingly, a maximum distance T1 of each component of the device 12, 13, 13′ from the boundary wall 10.1, 10.2, 11, 17 is formed.

The device 12, 13, 13′ according to the invention shown according to an embodiment in FIG. 4 is shown in its operating position. Accordingly, in the operating position of the device 12, 13, 13′, the pivotable impact element 26 can be pivoted on the supporting element 24 about a pivot axle S such that the main orientations of the supporting element 24 and the impact element 26 extend in almost the same direction. In addition, a central line M of the supporting element 24 that extends in parallel with the main orientation of the supporting element 24 is shown in FIG. 4. The pivot axle S is arranged between the boundary wall 10.1, 10.2, 11, 17 and this central line M such that the supporting element 24 or the device 12, 13, 13′ is arranged closer to the boundary wall 10.1, 10.2, 11, 17 in its operating position. Accordingly, the maximum distance T2 of each component of the device 12, 13, 13′ shown in FIG. 4 from the boundary wall 10.1, 10.2, 11, 17 in the operating position of said device is formed.

As a result of the described pivotability of the impact element 26 with respect to the supporting element 24, the distance T2 shown in FIG. 4 is smaller than the distance T1 shown in FIG. 3, such that the volume of an elevator shaft 8 that can be used by movement paths 15, 16 can be as large as possible according to a device 12, 13, 13′ shown in FIG. 4.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator system having a device arranged within an elevator shaft for creating a temporary protective space, wherein the elevator system has a travel body movable along an entire movement path in an operating mode of the elevator system, the device comprising:
a fastening element fixed in the elevator shaft;
a supporting element connected to the fastening element, wherein, in a maintenance position of the device, the supporting element is arranged within the elevator shaft such that the movement path of the travel body is limited to less than the entire movement path thereby forming a temporary protective space in the elevator shaft; and
an impact element connected to the supporting element, wherein, in the maintenance position of the device, the impact element is provided for direct mechanical contact with the travel body, and wherein the impact element is pivotably mounted on the supporting element for movement between the maintenance position and an operating position in which the movement path of the travel body is not limited by the device.

15. The elevator system according to claim 14 wherein the supporting element is connected to the fastening element for movement relative to the fastening element between the maintenance position and the operating position.

16. The elevator system according to claim 14 wherein the travel body is an elevator car or a counterweight that moves in a direction opposite to a movement direction of the elevator car.

17. The elevator system according to claim 14 wherein the fastening element is fixed to a shaft wall of the elevator shaft or to a shaft bottom of the elevator shaft.

18. The elevator system according to claim 14 wherein the impact element is mounted on the supporting element by a pivot axle such that, in the operating position of the device, the pivot axle is arranged between a central line of the supporting element that is oriented in a main orientation of the supporting element and a boundary wall of the elevator shaft.

19. The elevator system according to claim 14 wherein the supporting element is pivotably arranged on the fastening element.

20. The elevator system according to claim 14 wherein the supporting element is detachable from the fastening element for transferring the device from the maintenance position to the operating position.

21. The elevator system according to claim 20 including another fastening element to which the supporting element can be connected when the device is in the operating position.

22. A device for creating a temporary protective space, wherein the device is adapted for use in an elevator system when installed in an elevator shaft of the elevator system, the device comprising:
a fastening element adapted to be fixed in the elevator shaft;
a supporting element connected to the fastening element, wherein, in a maintenance position of the device, the supporting element is arranged within the elevator shaft such that a movement path of a travel body included in the elevator system is limited to form a temporary protective space in the elevator shaft; and
an impact element connected to the supporting element and wherein, in the maintenance position of the device, the impact element is provided for direct mechanical contact with the travel body, and wherein the impact element is pivotably mounted on the supporting element for movement between the maintenance position and an operating position of the device.

23. The device according to claim 22 wherein the supporting element is connected to the fastening element for movement of the supporting element between the maintenance position and the operating position.

24. The device according to claim 22 wherein the fastening element is adapted to be fixed to a shaft wall of the elevator shaft or to a shaft bottom of the elevator shaft.

25. The device according to claim 22 wherein the supporting element is pivotably arranged on the fastening element.

26. The device according to claim 22 wherein the supporting element is detachable from the fastening element for transferring the device from the maintenance position to the operating position.
